(19) United States
(12) Patent Application Publication
(10) Pub. No.: US 2011/0075630 A1
(43) Pub. Date: Mar. 31, 2011

(54) ENABLING INTER FREQUENCY ASSIGNMENT SCANNING WHILE REMAINING AT ONE FREQUENCY

(76) Inventor: Eilon Riess, Zichron-Yaakov (IL)

(21) Appl. No.: 12/567,298

(22) Filed: Sep. 25, 2009

(51) Int. Cl. H04W 4/00; H04B 17/00; H04L 27/00

(52) U.S. Cl. 370/331; 455/62; 375/259

(57) ABSTRACT

Techniques for enabling inter frequency assignment scanning while remaining at one frequency are described. In one embodiment, for example an apparatus may include a wireless interface subsystem, a memory and a processor. The memory may include data and instructions to operate the processor to communicate with a first fixed device at a first frequency during a first communication session, scan for one or more first preambles at the first frequency from a second fixed device and scan for one or more second preambles at the first frequency from a third fixed device. In an embodiment, the second fixed device may operate at a second frequency and the third fixed device may operate at a third frequency. The apparatus may include a processor operative to perform a handover based on the one or more first preambles and the one or more second preambles for a second communication session.

### BACKGROUND

A mobile device, such as a cellular telephone, typically communicates with a fixed device, such as a base station, over a portion of radio-frequency (RF) spectrum. For example, the mobile device and fixed device communicate over one or more RF communication channels. A mobile device constantly determines the next fixed device to communicate with as the mobile device moves between cellular networks. Each fixed device usually transmits signals at a different frequency in order to decrease the amount of interference between fixed devices. As a result, the mobile device must change frequencies to scan for signals from neighboring fixed devices. While the mobile device is scanning the frequencies from neighboring fixed devices, the mobile device normally cannot operate since it is on a different frequency. As the mobile device may scan for neighboring fixed devices periodically (e.g. 50 milliseconds), the operation of the mobile device is limited by its need to change frequencies.

### BRIEF DESCRIPTION OF THE DRAWINGS

FIG. 1 illustrates one embodiment of a first communications system.

FIG. 2 illustrates one embodiment of an apparatus.

FIG. 3 illustrates one embodiment of a frame structure.

FIG. 4 illustrates one embodiment of an exemplary logic flow.

### DETAILED DESCRIPTION

Various embodiments may be generally directed to enabling inter frequency assignment scanning while remaining at one frequency. In one embodiment, for example an apparatus may include a wireless interface subsystem, a memory and a processor. The memory may include data and instructions to operate the processor to communicate with a first fixed device at a first frequency during a first communication session. One or more first preambles may be scanned at the first frequency from a second fixed device. One or more second preambles may be scanned at the first frequency from a third fixed device. In an embodiment, the second fixed device may operate at a second frequency and the third fixed device may operate at a third frequency. The apparatus may include a processor operative to perform a handover based on the one or more first preambles and the one or more second preambles for a second communication session. In this manner, a mobile device may scan neighboring fixed devices to determine future handovers without interrupting its communication with its current fixed device. Other embodiments may be described and claimed.

The Internet is leaping towards mobile applications. This evolution is demanding ubiquitous communications at high data rates. Mobile broadband communications systems utilizing orthogonal frequency-division multiplexing (OFDM) and orthogonal frequency-division multiple access (OFDMA) techniques are emerging as one of the dominant technologies to fulfill high data rate demands.

Various embodiments may comprise a mobile broadband communications system having various types of wireless devices, such as a fixed device and a mobile device. An example of a mobile communications system may comprise a cellular radiotelephone system utilizing OFDM and/or OFDMA techniques. An example of a fixed device may comprise fixed equipment for a cellular radiotelephone system, such as a base station or node B. An example of a mobile device may comprise a mobile subscriber station (MSS) for a cellular radiotelephone system. An example of a mobile device may comprise a wireless communications device or a mobile station.

The fixed device and the mobile device may communicate and exchange channel information. The exchanged information may further include, among other information, cell type, loading, location, carrier to interference-plus-noise ratio (CINR) and received signal strength indication (RSSI). The embodiments are not limited in this context.

A mobile device may communicate with a first fixed device on a first frequency inside a cellular network. While communicating with the first fixed device, the mobile device may be moving and may need to find a new fixed device to communicate with on a new cellular network. As a result, the mobile device is constantly scanning for which neighboring fixed device it will communicate with next.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

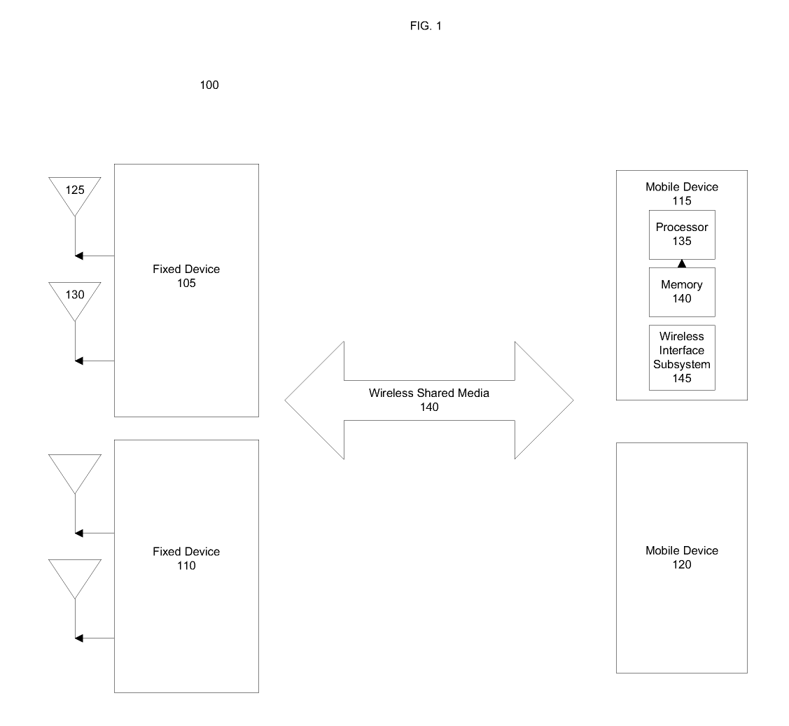

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links, such as wireless shared media 140. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands. In the latter case, the wireless nodes may include one or more wireless interface subsystems and/or components for wireless communication, such as one or more radios, transmitters, receivers, transceivers, chipsets, amplifiers, filters, control logic, network interface cards (NICs), antennas, antenna arrays, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth. In one embodiment, certain devices may include antenna arrays of multiple antennas to implement various adaptive antenna techniques and spatial diversity techniques.

As shown in the illustrated embodiment of FIG. 1, the communications system 100 comprises multiple elements, such as one or more fixed devices 105, 110 and one or more mobile devices 115, 120 all of which communicate via wireless shared media 140. As shown by the fixed device 105, the fixed devices may include two or more wireless interface subsystems 125, 130. As shown by the mobile device 115, the mobile devices 115 may include a processor 135, a memory unit 140, and a wireless interface subsystem 145. The embodiments, however, are not limited to the elements shown in FIG. 1.

In various embodiments, the communications system 100 may comprise or be implemented as a mobile broadband communications system. Examples of mobile broadband communications systems include without limitation systems compliant with various Institute of Electrical and Electronics Engineers (IEEE) standards, such as the IEEE 802.11 standards for Wireless Local Area Networks (WLANs) and variants, the IEEE 802.16 standards for Wireless Metropolitan Area Networks (WMANs) and variants, and the IEEE 802.20 or Mobile Broadband Wireless Access (MBWA) standards and variants, among others. In one embodiment, for example, the communications system 100 may be implemented in accordance with the Worldwide Interoperability for Microwave Access (WiMAX) or WiMAX II standard. WiMAX is a wireless broadband technology based on the IEEE 802.16 standard of which IEEE 802.16-2004 and the 802.16e amendment (802.16e Cor2/D3-2005) are Physical (PHY) layer specifications. WiMAX II is an advanced Fourth Generation (4G) system based on the IEEE 802.16m and IEEE 802.16j proposed standards for International Mobile Telecommunications (IMT) Advanced 4G series of standards. Although some embodiments may describe the communications system 100 as a WiMAX or WiMAX II system or standards by way of example and not limitation, it may be appreciated that the communications system 100 may be implemented as various other types of mobile broadband communications systems and standards, such as a Universal Mobile Telecommunications System (UMTS) system series of standards and variants, a Code Division Multiple Access (CDMA) 2000 system series of standards and variants (e.g., CDMA2000 1xRTT, CDMA2000 EV-DO, CDMA EV-DV, and so forth), a High Performance Radio Metropolitan Area Network (HIPERMAN) system series of standards as created by the European Telecommunications Standards Institute (ETSI) Broadband Radio Access Networks (BRAN) and variants, a Wireless Broadband (WiBro) system series of standards and variants, a Global System for Mobile communications (GSM) with General Packet Radio Service (GPRS) system (GSM/GPRS) series of standards and variants, an Enhanced Data Rates for Global Evolution (EDGE) system series of standards and variants, a High Speed Downlink Packet Access (HSDPA) system series of standards and variants, a High Speed Orthogonal Frequency-Division Multiplexing (OFDM) Packet Access (HSOPA) system series of standards and variants, a High-Speed Uplink Packet Access (HSUPA) system series of standards and variants, 3rd Generation Partnership Project (3GPP) Rel. 8 and 9 of Long Term Evolution (LTE)/System Architecture Evolution (SAE) and so forth. The embodiments are not limited in this context.

In various embodiments, the communications system 100 may comprise a fixed device 110 having wireless capabilities. A fixed device 110 may comprise a generalized equipment set providing connectivity or information to another wireless device, such as one or more mobile devices. Examples for the fixed device 105, 110 may include a wireless access point (AP), base station or node B, router, switch, hub, gateway, and so forth. In one embodiment, for example, the fixed device may comprise a base station or node B for a cellular radiotelephone system or mobile broadband communications system. The fixed device 105, 110 may also provide access to a network (not shown). The network may comprise, for example, a packet network such as the Internet, a corporate or enterprise network, a voice network such as the Public Switched Telephone Network (PSTN), and so forth. Although some embodiments may be described with the fixed device 105, 110 implemented as a base station or node B by way of example, it may be appreciated that other embodiments may be implemented using other wireless devices as well. The embodiments are not limited in this context.

In various embodiments, the communications system 100 may comprise a set of mobile devices 115, 120 having wireless capabilities. The mobile devices 115, 120 may comprise a generalized equipment set providing connectivity to other wireless devices, such as other mobile devices or fixed devices (e.g., fixed device 110). Examples for the mobile devices 115, 120 may include without limitation a computer, server, workstation, notebook computer, handheld computer, telephone, cellular telephone, personal digital assistant (PDA), combination cellular telephone and PDA, and so forth. In one embodiment, for example, the mobile devices 115, 120 may be implemented as mobile subscriber stations (MSS) for a WMAN. Although some embodiments may be described with the mobile devices 115, 120 implemented as a MSS by way of example, it may be appreciated that other embodiments may be implemented using other wireless devices as well. The embodiments are not limited in this context.

As shown by the mobile device 115, the mobile device 115 may comprise a processor 135. The processor 135 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processor 135 may be implemented as a general purpose processor, such as a processor made by Intel® Corporation, Santa Clara, Calif. The processor 135 may be implemented as a dedicated processor, such as a controller, microcontroller, embedded processor, a digital signal processor (DSP), a network processor, a media processor, an input/output (I/O) processor, and so forth. The embodiments are not limited in this context.

As further shown by the mobile device 115, the mobile device 115 may comprise a memory unit 140. The memory 140 may comprise any machine-readable or computer-readable media capable of storing data, including both volatile and non-volatile memory. For example, the memory 140 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of the memory 140 may be included on the same integrated circuit as the processor 135, or alternatively some portion or all of the memory 140 may be disposed on an integrated circuit or other medium, for example a hard disk drive, that is external to the integrated circuit of the processor 135. In an embodiment, the memory may include data and instructions to operate the processor. The embodiments are not limited in this context.

In various embodiments, the mobile device 115 and the fixed device 105 may communicate information over wireless shared media 140 via respective wireless interface subsystems 125, 130, 145. The wireless shared media 140 may comprise one or more allocations of RF spectrum. The allocations of RF spectrum may be contiguous or non-contiguous. In some embodiments, the wireless interface subsystems 125, 130, 145 may communicate information over the wireless shared media 140 using various multicarrier techniques utilized by, for example, WiMAX or WiMAX II systems. For example, the wireless interface subsystems 125, 130, 145 may utilize various Multiple-Input Multiple-Output (MIMO) techniques to perform beam forming, spatial diversity or frequency diversity.

In general operation, the wireless interface subsystem 125, 130, 145 may communicate information using one or more communications channels. A communication channel may be a defined set of frequencies, time slots, codes, or combinations thereof.

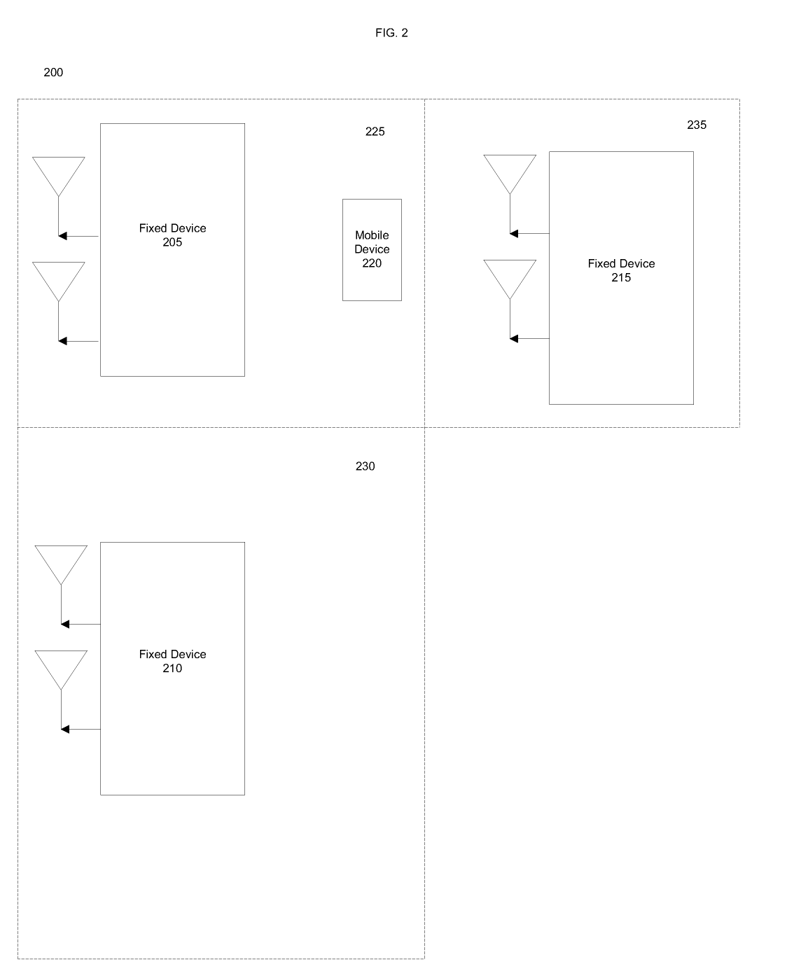

FIG. 2 discloses a mobile device communicating with various fixed devices. The communications system 200 is a mobile broadband communications system designed to maintain communications operations when a mobile device 220 is moving and process a handover from a first fixed device to a second fixed device. In an embodiment, a mobile device 220 may be in communication with fixed device 205 in a network cell 225.

In an embodiment, each fixed device 205, 210, 215 may operate on a different communication channel frequency. The fixed devices 205, 210, 215 may operate on different frequencies to ensure that there is no interference between them. In an embodiment, a mobile device 220 and a first fixed device 205 may communicate on a first frequency while a first neighboring fixed device 210 may transmit signals on a second frequency and a second neighboring device 215 may transmit signals on a third frequency.

The mobile device 220 may scan neighboring fixed devices to determine a handover when the mobile device reaches a new cellular network 230, 235. In an embodiment, handovers may be determined by a mobile device 220 scanning fixed devices 210, 215 to determine the best signal. The best signal may be determined using indicators such as, cell type, location, loading the carrier to interference-plus-noise ratio (CINR) and the received signal strength indication (RSSI). In an embodiment, an indicator may be the channel capability to support MIMO. The embodiments are not limited in this context.

In order for the mobile device to determine which fixed device to use for a future handover, the frequency from each fixed device may be scanned multiple times. The mobile device may test each signal for the indicators multiple times in order to average the various results. By scanning each frequency multiple times and averaging the indicators, the frequencies may be compared without temporary fading effects causing inaccurate information. Currently, in order to scan the fixed devices, the mobile device must switch to the frequency of that fixed device. When the mobile device is switched to a frequency, other than the frequency it is currently using to communicate, the mobile device may not be operational. This results in time delays when information is being sent and received as no information can be transmitted or received when the mobile device is operating in a different frequency. Due to the combination of the time intervals between scan periods and the relatively long time it takes to visit each frequency, a long period of time is needed to scan all neighboring fixed devices. This is particularly true as each neighborhood fixed device may be scanned several times for the purpose of averaging out temporary fading effects. As a result, it is hard to ensure that the mobile device is being served by the best fixed device since the mobile device may be moving through a geographic area quickly and there may be many neighborhood fixed devices to scan. Additionally, the frames which are sent are only for measuring neighboring fixed devices and waste energy as no information is being transferred.

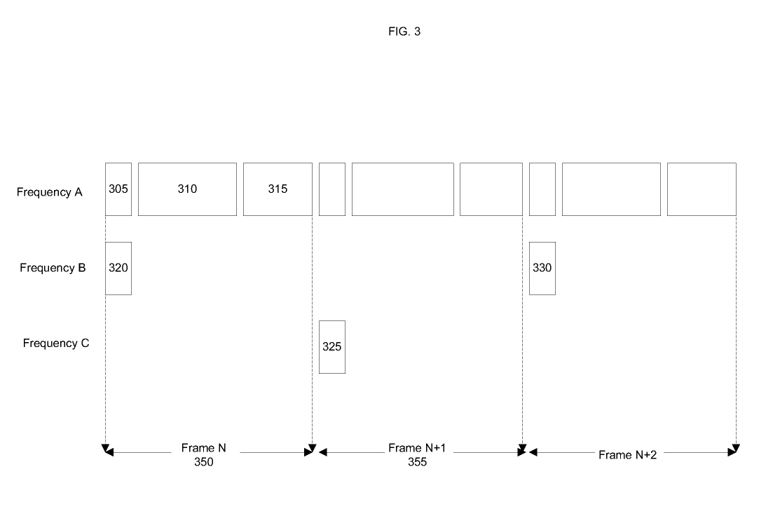

To solve these and other problems, the neighboring fixed devices 215, 220 may emit multiple signals on multiple frequencies. FIG. 3 discloses a fixed device emitting various frequencies in the preamble of frames. In an embodiment, the fixed device may send data wirelessly via a digital data transmission. In an embodiment, the data may be sent as one or more frames. A frame is a digital data transmission from a linked layer protocol. A frame may include a preamble, an upload packet and a download packet.

As used herein, the term packet may include a unit of data that may be routed or transmitted between nodes or stations or across a network. As used herein, the term packet may include frames, protocol data units or other units of data. A packet may include a group of bits, which may include one or more address fields, control fields and data, for example.

In an embodiment, a fixed device may operate on frequency A. Referring to FIG. 3, the fixed device may emit multiple frames 350, each with a preamble 305, a download packet 310 and an upload packet 315. The embodiments are not limited in this context. The fixed device may send multiple frames during a data transmission. In an embodiment, the information may be emitted from a wireless interface subsystem. In an embodiment, the wireless interface subsystem may include a first antenna.

In an embodiment, the fixed device may transmit preambles on one or more other frequencies on a separate wireless interface subsystem such as, but not limited to, a second antenna. In an embodiment, the fixed device may transmit, on a second antenna, one or more preambles on non-operational frequencies. If the device transmits one or more preambles on a non-operational frequency, the resuse is greater than one. For example, in FIG. 3, the fixed device may transmit frequency B and frequency C from a second antenna. The fixed device may transmit a preamble 320 on frequency B during a first frame 350. The fixed device may then transmit a preamble 325 on frequency C during a second frame 355. In an embodiment, the second antenna may be operative to transmit upload and download packets from the first fixed device after the preamble is transmitted.

In an embodiment, the antenna on a fixed device may only transmit a single preamble during a frame. However, the antenna may transmit preambles for multiple non-operational frequencies (such as frequency B and frequency C). In an embodiment, the antenna on a fixed device may send preambles on different frequencies in different frames. In an embodiment, the antenna on a fixed device may alternate the frequencies sent out over the preamble of the frame. For example, in FIG. 3, the preamble 320, 330 associated with frequency B may be sent on every even numbered frame while the preamble 325 associated with frequency C may be sent on every odd numbered frame. If the fixed device emits preambles on three different frequencies, then the frequency reuse is 3.

By allowing the fixed device to send preambles on multiple frequencies, the mobile device may receive the preamble in the frequency in which it is currently communicating. For example, referring to FIG. 3, if a mobile device was communicating on frequency C, then the mobile device may receive the preamble from the fixed device in every other frame.

In an embodiment, a fixed device may send preambles on two different frequencies from a second antenna. In an embodiment, the first preamble may be sent on a first frame of a data communication while a second preamble may be sent on a second frame of the data communication. In an embodiment, first preambles may be sent on every even numbered data communication frame while second preambles may be sent on every odd numbered data communication frame. In an embodiment, first preambles may be sent on every odd numbered data communication frame while second preambles may be sent on every even numbered data communication frame.

In alternate embodiments, a fixed device may send preambles on three or more frequencies from a second antenna. In an embodiment, a fixed device may transmit five different frequencies. The embodiments, however, are not limited to this example. The fixed device may include a first antenna and a second antenna. A first frequency A may be an operational frequency. A first antenna may send one or more frames in frequency A, each with a preamble, an upload packet and a download packet. The second antenna may send preambles for the other four frequencies in alternating frames. For example, the first frame may include a preamble with frequency B, the second frame may include a preamble with frequency C, the third frame may include a preamble with frequency D and the fourth frame may include a preamble with frequency E. As a result, after four frames (i.e. the number of different frequencies minus one), the fixed device will have broadcast preambles on all the frequencies. After the fourth frame, the sequence may repeat, beginning with the fifth frame including a preamble with frequency B.

While the preambles are broadcast on the various frequencies, a mobile device operating with a fixed device, can remain at the operating frequency and scan the other fixed devices to perform measurement of the signals from the neighboring cells for a handover decision. In an embodiment, the mobile device may perform scanning of the frequencies from the neighboring fixed devices without having to change to a different frequency.

For example, the mobile device may communicate with a first fixed device on a first frequency. A second fixed device may communicate on a second frequency. The second fixed device may send out a preamble in the second frequency, which is the operational frequency. Additionally, the second fixed device may send out a preamble on the first frequency from a dedicated communication interface such as, but not limited to, an antenna. As the mobile device is currently operating on the first frequency, it will receive the second fixed device's preamble on the first frequency. In an embodiment, the mobile device may scan for preambles transmitted from neighboring fixed devices without interrupting its communication with the first fixed device at the first frequency. In an embodiment, the mobile device may scan for preambles from one or more fixed devices at any time. As the mobile device does not have to change frequencies in order to scan, the scanning may be completed more quickly and will not interrupt the current communication between the mobile device and the current fixed device.

During and/or after the scan, the mobile device may perform a measurement on the preamble received from the second fixed device on the first frequency. The mobile device may scan preambles, from the second fixed device on the first frequency, a plurality of times. As a result of the multiple preambles transmitted from a fixed device, the mobile device may determine an accurate measurement of the signal from the fixed device. By scanning each frequency multiple times and averaging the information, the frequencies may be compared without temporary fading effects causing inaccurate information.

While the mobile device is receiving preambles on non-operational frequencies of two of more fixed devices, the mobile device may measure the preambles to determine which fixed device it will chose to perform the handover. By averaging the preambles from the non-operational frequencies from a fixed device, an accurate measurement of the signal from the fixed device may be obtained.

In an embodiment, the values may be averaged to determine various indicators such as, but not limited to cell type, loading, location, carrier to interference-plus-noise ratio (CINR) and received signal strength indication (RSSI). In an embodiment, based on the carrier to interference-plus-noise ratio (CINR) and/or received signal strength indication (RSSI) values, the mobile device may determine which device will be chosen for a handover. For example, the fixed device with the highest RSSI will be chosen for the handover. In another example, the fixed device with the highest CINR will be chosen for the handover. In an embodiment, the fixed device that can give the best CINR, RSSI, and/or spectral efficiency may be the target fixed device to complete the handover.

In an embodiment, the mobile device may perform a handover. The handover procedure may be initiated by a mobile device or a fixed device. In an embodiment, the fixed device currently interacting with the mobile device may instruct the mobile device to scan neighboring fixed devices when a CINR and/or a RSSI threshold is breached. In an embodiment, a mobile device may begin scanning for a handover based on a command. The embodiments are not limited in this context.

In an embodiment, a mobile device may initiate a handover by transmitting a handover initiation message to a fixed device. The message may be transmitted to the fixed device to which the mobile device is currently in communication. The fixed device may respond to the handover initiation message by sending a handover command message to the mobile device. Alternatively, the fixed device in communication with the mobile device may initiate the handover by sending a handover initiation message to the mobile device. The mobile device may respond to the message. The handover message may include one or more neighboring fixed devices chosen to complete the handover. If a single fixed device is included in the handover message, the mobile device may execute the handover as directed by that fixed device. If multiple fixed devices are included in the handover message, the mobile device must choose a fixed device and send a handover indication message to the current fixed device stating which fixed device was chosen.

In an embodiment, during the handover preparation phase, the current fixed device may communicate with the fixed device chosen for the handover. The chosen fixed device may obtain information about the mobile device from the current fixed device via backbone network for handover optimization. In an embodiment, a dedicated ranging resource at the chosen fixed device may be reserved for the mobile device to facilitate non-contention-based handover ranging. In an alternate embodiment, the ranging may be completed prior to the handover. If there is only a single chosen fixed device, the handover preparation phase may be completed when the current fixed device informs the mobile device of its handover decision via handover command control signaling. If there are multiple chosen fixed devices, the handover preparation phase may be completed when mobile device informs the current fixed device of its chosen fixed device via handover indication control signaling.

During the handover execution, at a specific time in the handover command control signaling, the mobile device may perform network re-entry at the chosen fixed device. If communication is not maintained between the mobile device and the current fixed device during network re-entry at the chosen fixed device, the current fixed device may stop allocating resources for the mobile device for transmission at the specified time. If directed by the current fixed device via handover command control signaling, the mobile device may perform network re-entry with the chosen fixed device at the specified time while continuously communicating with the current fixed device. However, the mobile device may stop communicating with the current fixed device after network re-entry at the chosen fixed device is completed.

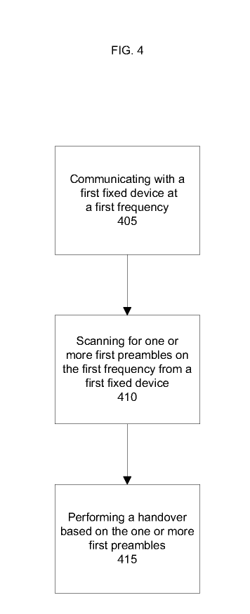

FIG. 4 illustrates a programming logic 400 for enabling inter frequency scanning while remaining at one frequency according to an embodiment. The logic flow 400 may be representative of the operations executed by one or more embodiments described herein. The logic flow 400 may be representative of the operations executed by one or more embodiments described herein, such as one of the devices 115, 120, 220 from FIG. 1 and FIG. 2. As shown in the logic flow 400, a mobile device may communicate with a first fixed device on a first frequency during a first communication session at block 405. The mobile device may receive one or more frames during the communication session. In an embodiment, a preamble, an upstream packet and a downstream packet may be received from the first fixed device on the first frequency.

One or more first preambles on the first frequency may be received from a second fixed device at block 410. For example, the fixed device may receive two first preambles. While both preambles are on the first frequency, each preamble may have a different sequence. In an embodiment, the preambles may have different sequences. In an embodiment, the preambles may have the same sequence. In an embodiment, the second fixed device may be in close proximity or neighboring the first fixed device. In an embodiment, the second fixed device may operate on a second frequency. In an embodiment, the first frequency may not be equal to the second frequency. In an embodiment, the one or more first preambles received from a second fixed device may have a distinctive sequence which does not or minimally interferes with the communication from the first fixed device. In an embodiment, scanning for the one or more first preambles from a second device may occur during the communicating with a first fixed device.

In an embodiment, one or more second preambles on the first frequency may be received from a third fixed device. In an embodiment, the third fixed device may be in close proximity or neighboring the first fixed device and/or the second fixed device. The third fixed device may operate on a third frequency. In an embodiment, the third frequency may not be equal to the first frequency or the second frequency. In an embodiment, the one or more second preambles received from a third fixed device may have a distinctive sequence which does not interfere with the communication from the first fixed device. In an embodiment, scanning for the one or more second preambles from a third device may occur during the communicating with a first fixed device.

A handover may be performed based on the one or more first preambles at block 415. In an embodiment, a handover from the first fixed device to the second fixed device may be performed. In an embodiment, if one or more second preambles on the first frequency are received from a third fixed device, a handover from the first fixed device to the third fixed device may be performed. In an embodiment, a handover from the first fixed device to the third fixed device may be based on the one or more first preambles and the one or more second preambles. In an embodiment, a handover may include determining an average single strength, carrier to interference-plus-noise ratio (CINR) and/or received signal strength indication (RSSI) value for the one or more first preambles and/or the one or more second preambles. In an embodiment, the average single strength, CINR and/or RSSI value for the one or more first preambles may be compared with the average single strength, CINR and/or RSSI value for the one or more second preambles.

In an embodiment, performing a handover may include changing from the first frequency to another frequency. In an embodiment, performing a handover may include changing from the first frequency to the second frequency for the second communication session. In an embodiment, performing a handover may include changing from the first frequency to the third frequency for the second communication session. In an embodiment, the second communication session may begin on the second frequency. In an embodiment, the second communication session may begin on the third frequency. The changing of the frequency may complete the handover. In an embodiment, the first communication session with the first fixed device may be terminated. In an embodiment, after the handover has been completed the first communication session may be terminated.

In an embodiment, the mobile device may have left the current or first fixed device and it may take 50 Msec to complete the handover with the chosen or second fixed device. In this 50 Msec, no data communication may occur. However, pre-data procedure may be provided to the second fixed device. In an embodiment, there may be an option to complete the handover without losing the data connection with the current or first fixed device until the moment the data connection is resumed with the chosen or second fixed device.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A wireless communications device comprising:
a wireless interface subsystem; and
a processor and memory, the memory including data and instructions to operate the processor to:
communicate with a first fixed device at a first frequency during a first communication session,
scan for one or more first preambles at the first frequency from a second fixed device, wherein the second fixed device operates at a second frequency, and
perform a handover based on the one or more first preambles for a second communication session.

2. The wireless communications device of claim 1 wherein each of the one or more first preambles has a distinctive sequence which does not interfere with the first communication session.

3. The wireless communications device of claim 1 wherein the processor is further operative to:
terminate the first communication session with the first fixed device.

4. The wireless communications device of claim 1 wherein the processor is further operative to:
scan for one or more second preambles at the first frequency from a third fixed device, wherein the third fixed device operates at a third frequency.

5. The wireless communications device of claim 4 wherein each of the one or more second preambles has a distinctive sequence which does not interfere with the first communication session.

6. The wireless communications device of claim 1 wherein the processor is further operative to:
determine an average carrier to interference-plus-noise ratio for the one or more first preambles.

7. The wireless communications device of claim 1 wherein the processor is further operative to:
determine an average received signal strength indication for the one or more first preambles.

8. A wireless fixed device comprising:
a first antenna operative to transmit a preamble at a first frequency, wherein the first frequency is an operational frequency, and
a second antenna operative to transmit a second preamble at a second frequency, wherein the second frequency is a non-operational frequency.

9. The wireless fixed device of claim 6 wherein the second antenna is further operative to:
transmit a third preamble at a third frequency, wherein the third frequency is a non-operational frequency.

10. The wireless fixed device of claim 9 wherein the second antenna alternates transmitting the second preamble at the second frequency with transmitting the third preamble at the third frequency.

11. The wireless fixed device of claim 8 wherein the second antenna is further operative to:
transmit upload and download packets on the first frequency after the second preamble is transmitted.

12. A method comprising:
communicating with a first fixed device at a first frequency during a first communication session;
scanning for one or more first preambles at the first frequency from a second fixed device, wherein the second fixed device operates at a second frequency; and
performing a handover for a second communication session based on the one or more first preambles.

13. The method of claim 12 wherein the first frequency does not equal the second frequency.

14. The method of claim 12 wherein the performing a handover comprises changing from the first frequency in the first communication session to the second frequency for the second communication session.

15. The method of claim 12 wherein the communicating with a first fixed device at a first frequency occurs during the scanning for one or more first preambles.

16. The method of claim 12 wherein the communicating with a first fixed device at a first frequency comprises:
receiving a preamble, an upstream packet and a downstream packet from the first fixed device on the first frequency.

17. The method of claim 12, further comprising:
scanning for one or more second preambles at the first frequency from a third fixed device, wherein the third fixed device operates at a third frequency.

18. The method of claim 17 wherein the second frequency does not equal the third frequency.

19. The method of claim 17 wherein the performing a handover comprises:
determining an average received signal strength indication for the one or more first preambles;
determining an average received signal strength indication for the one or more second preambles; and
comparing the average received signal strength indication for the one or more first preambles with the average received signal strength indication for the one or more second preambles.

20. The method of claim 17 wherein the performing a handover comprises:
determining an average carrier to interference-plus-noise ratio for the one or more first preambles;
determining an average carrier to interference-plus-noise ratio for the one or more second preambles; and
comparing the average carrier to interference-plus-noise ratio for the one or more first preambles with the average carrier to interference-plus-noise ratio for the one or more second preambles.
